(19) United States
(12) Patent Application Publication
(10) Pub. No.: US 2013/0006633 A1
(43) Pub. Date: Jan. 3, 2013

(54) LEARNING SPEECH MODELS FOR MOBILE DEVICE USERS

(75) Inventors: Leonard Henry Grokop, San Diego, CA (US); Vidya Narayanan, San Diego, CA (US)

(73) Assignee: QUALCOMM Incorporated, San Diego, CA (US)

(21) Appl. No.: 13/344,026

(22) Filed: Jan. 5, 2012

Related U.S. Application Data
(60) Provisional application No. 61/504,080, filed on Jul. 1, 2011.

(51) Int. Cl. G10L 15/06

(52) U.S. Cl. 704/245; 704/E15.008

(57) ABSTRACT

Techniques are provided to recognize a speaker's voice. In one embodiment, received audio data may be separated into a plurality of signals. For each signal, the signal may be associated with value/s for one or more features (e.g., Mel-Frequency Cepstral coefficients). The received data may be clustered (e.g., by clustering features associated with the signals). A predominate voice cluster may be identified and associated with a user. A speech model (e.g., a Gaussian Mixture Model or Hidden Markov Model) may be trained based on data associated with the predominate cluster. A received audio signal may then be processed using the speech model to, e.g.: determine who was speaking; determine whether the user was speaking; determining whether anyone was speaking; and/or determine what words were said. A context of the device or the user may then be inferred based at least partly on the processed signal.

### CROSS-REFERENCES TO RELATED APPLICATIONS

The present application is a non-provisional patent application, claiming the benefit of priority of U.S. Provisional Application No. 61/504,080, filed on Jul. 1, 2011, entitled, “LEARNING SPEECH MODELS,” which is hereby incorporated by reference in its entirety.

### BACKGROUND

Many mobile devices include a microphone, such that the device can receive voice signals from a user. The voice signals may be processed in an attempt to determine, e.g., whether the voice signals include a word of interest (e.g., to cause the device to execute a particular program). However, voice signals associated with any given word are highly variable. For example, voice signals may depend on, e.g., background noises, a speaker's identity, and a speaker's volume. Thus, it may be difficult to develop an algorithm that can reliably recognize words.

### SUMMARY

Techniques are provided to recognize a user's voice and/or words spoken by a user. In one embodiment, “training” audio data may be received. Training data may be obtained, e.g., by collecting audio data, e.g., when a mobile device is in a call state, when a particular application (e.g., a speech recognition application) is executing on a mobile device, when a user manually indicates that audio data should be collected, when a volume at a microphone is above a threshold, etc. Received audio data may be separated into a plurality of signals. For each signal, the signal may be associated with value/s for one or more features (e.g., Mel-Frequency Cepstral coefficients). The received data may be clustered (e.g., by clustering features associated with the signals). A predominate voice cluster may be identified and associated with a user. A speech model (e.g., a Gaussian Mixture Model or Hidden Markov Model) may be trained based on data associated with the predominate cluster. A received audio signal may then be processed using the speech model to, e.g.: determine who was speaking; determine whether the user was speaking; determining whether anyone was speaking; and/or determine what words were said. A context associated with the user or device is then inferred at least partly based on the processed signal.

In some embodiments, a method for training a user speech model is provided. The method may include: accessing audio data captured while a mobile device is in an in-call state; clustering the accessed audio data into a plurality of clusters, each cluster being associated with one or more audio segments from the accessed audio data; identifying a predominate voice cluster; and training the user speech model based, at least in part, on audio data associated with the predominate voice cluster. The method may further include: determining that the mobile device is currently in the in-call state. Determining that a mobile device is currently in an in-call state may include determining that the mobile device is currently executing a software application, wherein the software application collects user speech. The method may further include: receiving, at a remote server, the audio data from the mobile device. Identifying the predominate voice cluster may include: identifying one or more of the plurality of clusters as voice clusters, each voice cluster being primarily associated with audio segments estimated to include speech; and identifying a voice cluster that, relative to all other voice clusters, is associated with the greatest number of audio segments. Identifying the predominate voice cluster may include identifying a cluster that, relative to all other clusters, is associated with the greatest number of audio segments. The user speech model may be trained only using audio data captured while the device was in the in-call state. The user speech model may be trained after the predominate voice cluster is identified. The method may further include: storing at least part of the accessed audio data, wherein it is not possible to reconstruct a message spoken during the in-call state by a speaker based on the stored data. The trained user speech model may be trained to recognize words spoken by a user of the mobile device. The method may further include: analyzing a second set of audio data using the trained user speech model; recognizing, based on the analyzed audio data, one or more particular words spoken by a user; and inferring a context at least partly based on the recognized one or more words. The method may further include: accessing audio data captured while the mobile device is in a subsequent, distinct in-call state; clustering the accessed subsequent audio data; identifying a subsequent predominate voice cluster; and training the user speech model based, at least in part, on audio data associated with the subsequent predominate voice cluster. The method may further include: storing the accessed audio data; determining a plurality of cepstral coefficients associated with each of a plurality of portions of the accessed audio data; clustering the accessed audio data based on the determined cepstral coefficients, and training the user speech model based, at least in part, on the stored accessed audio data, wherein the stored audio data comprises temporally varying data. The user speech model may include a Hidden Markov Model and/or a. Gaussian Mixture Model. The method may further include: accessing second audio data captured after a user was presented with text to read, the accessed second audio data including a second set of speech segments, wherein the second set of speech segments are based on the presented text; and training the user speech model based, at least in part, on the second set of speech segments.

In some embodiments, an apparatus for training a user speech model is provided. The apparatus may include: a mobile device comprising: a microphone configured to, upon being in an active state, receive audio signals and convert the received audio signals into radio signals; and a transmitter configured to transmit the radio signals. The apparatus may also include: one or more processors configured to: determine that the microphone is in the active state; capture audio data while the microphone is in the active state; cluster the captured audio data into a plurality of clusters, each cluster being associated with one or more audio segments from the captured audio data; identify a predominate voice cluster; and train a user speech model based, at least in part, on audio data associated with the predominate voice cluster. The mobile device may include at least one and/or all of the one or more processors. The mobile device may be configured to execute at least one software application that activate the microphone. Audio data may, in some instances, be captured only when the mobile device is engaged in a telephone call.

In some embodiments, a computer-readable medium is provided. The computer-readable medium may include a program which executes the steps of: accessing audio data captured while a mobile device is in an in-call state; clustering the accessed audio data into a plurality of clusters, each cluster being associated with one or more audio segments from the accessed audio data; identifying a predominate voice cluster; and training the user speech model based, at least in part, on audio data associated with the predominate voice cluster. The step of identifying the predominate voice cluster may include identifying a cluster that, relative to all other clusters, is associated with the greatest number of audio segments. The program may further execute the step of: storing at least part of the accessed audio data, wherein it is not possible to reconstruct a message spoken during the in-call state by a speaker based on the stored data. The program may further execute the steps of: storing the accessed audio data; determining a plurality of cepstral coefficients associated with each of a plurality of portions of the captured audio data; clustering the accessed audio data based on the determined cepstral coefficients, and training the user speech model based, at least in part, on the stored accessed audio data, wherein the stored audio data comprises temporally varying data.

In some embodiments, a system for training a user speech model is provided. The system may include: means for accessing audio data captured while a mobile device is in an in-call state (e.g., a recorder and/or microphone coupled to the mobile device); means for clustering the accessed audio data into a plurality of clusters (e.g., a classifier), each cluster being associated with one or more audio segments from the captured audio data; means for identifying a predominate voice cluster; and means for training the user speech model based, at least in part, on audio data associated with the predominate voice cluster (e.g., a speech model). The means for training the user speech model may include means for training Hidden Markov Model. The predominate voice cluster may include a voice cluster associated with a highest number of audio frames. The system may further include means for identifying at least one of the clusters associated with one or more speech signals.

### BRIEF DESCRIPTION OF THE DRAWINGS

FIG. 1A illustrates an embodiment of an apparatus for learning speech models according to an embodiment of the present invention.

FIG. 1B is a diagram illustrating the capture of audio data according to an embodiment of the present invention.

FIG. 1C is a diagram illustrating the capture of audio data according to another embodiment of the present invention.

FIG. 1D is a diagram illustrating the capture of audio data according to still another embodiment of the present invention.

FIG. 2 is a flow diagram of a process usable by a mobile device for learning speech models according to an embodiment of the present invention.

FIG. 3 is a flow diagram of a process for learning speech models according to an embodiment of the present invention.

FIG. 4 is a flow diagram of a process for learning speech models according to an embodiment of the present invention.

FIG. 5 illustrates an embodiment of a computer system.

### DETAILED DESCRIPTION

Methods, devices and systems are provided to recognize a user's voice and/or words spoken by a user. In one embodiment, “training” audio data may be received. Training data may be obtained, e.g., by collecting audio data, e.g., when a mobile device is in a call state, when a particular application (e.g., a speech recognition application) is executing on a mobile device, when a user manually indicates that audio data should be collected, when a volume at a microphone is above a threshold, etc. Received audio data may be separated into a plurality of signals. For each signal, the signal may be associated with value/s for one or more features (e.g., Mel-Frequency Cepstral coefficients). The received data may be clustered (e.g., by clustering features associated with the signals). A predominate voice cluster may be identified and associated with a user. A speech model (e.g., a Gaussian Mixture Model or Hidden Markov Model) may be trained based on data associated with the predominate cluster. A received audio signal may then be processed using the speech model to, e.g.: determine who was speaking; determine whether the user was speaking; determining whether anyone was speaking; and/or determine what words were said. A context of the device or the user may then be inferred based at least partly on the processed signal.

A social context may be inferred at least partly based on the processed audio signal. For instance, if it is determined that a user is speaking, it may be unlikely that the user is in his office at work. If a user is not speaking, but many other people are speaking, it may be inferred that the user is in a public place. If the user is not speaking, but one other person is speaking, it may be inferred that the user is in a meeting. Based on an inferred context or on an inferred context property, specific actions may be performed (e.g., adjusting a phone's ring volume, blocking incoming calls, setting particular alerts, etc.).

User speech detection can also aid in inferring contexts related to a mobile device. For example, analyzing signals received by a microphone in a mobile may indicate how close the mobile device is to a user. Thus, signals may be processed to estimate whether, e.g., the device is in the user's pocket, near the user's head, in a different building than a user, etc. Specific actions (e.g., adjusting ring volume, adjusting hibernation settings, etc.) may again be performed based on inferred mobile-device-related context.

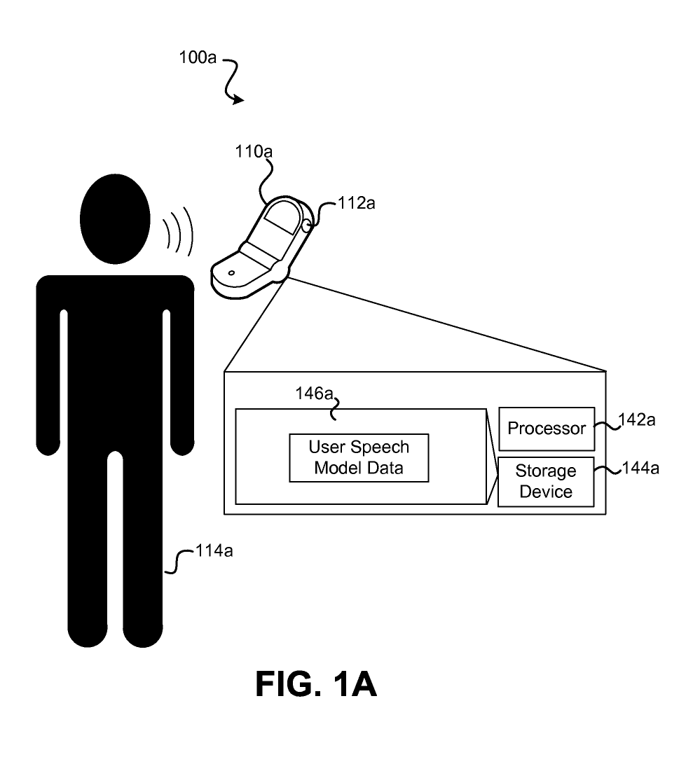

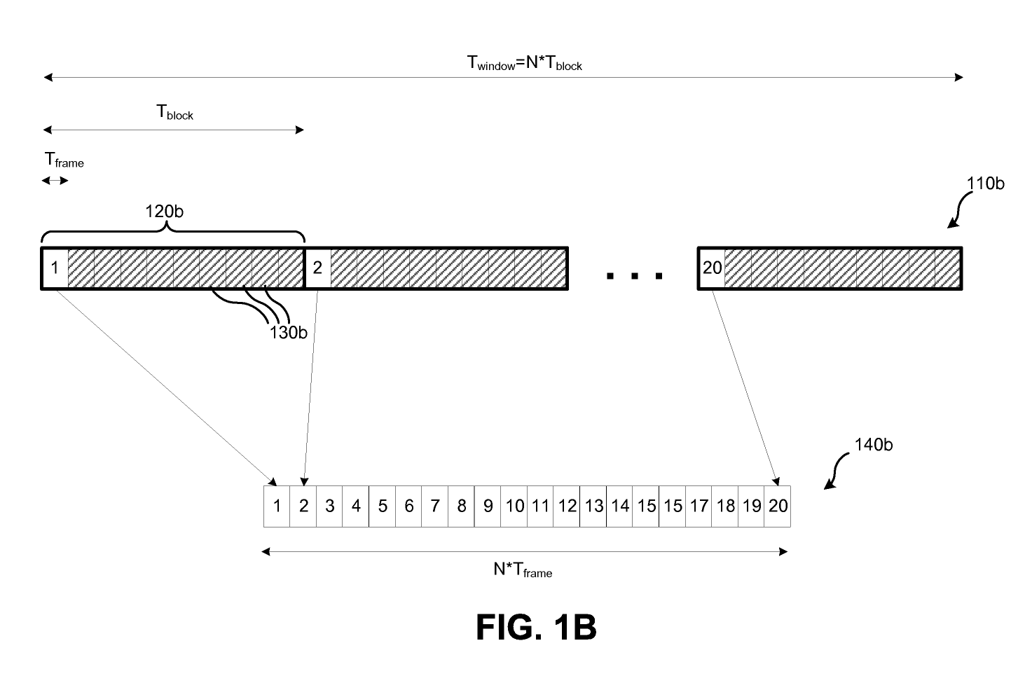

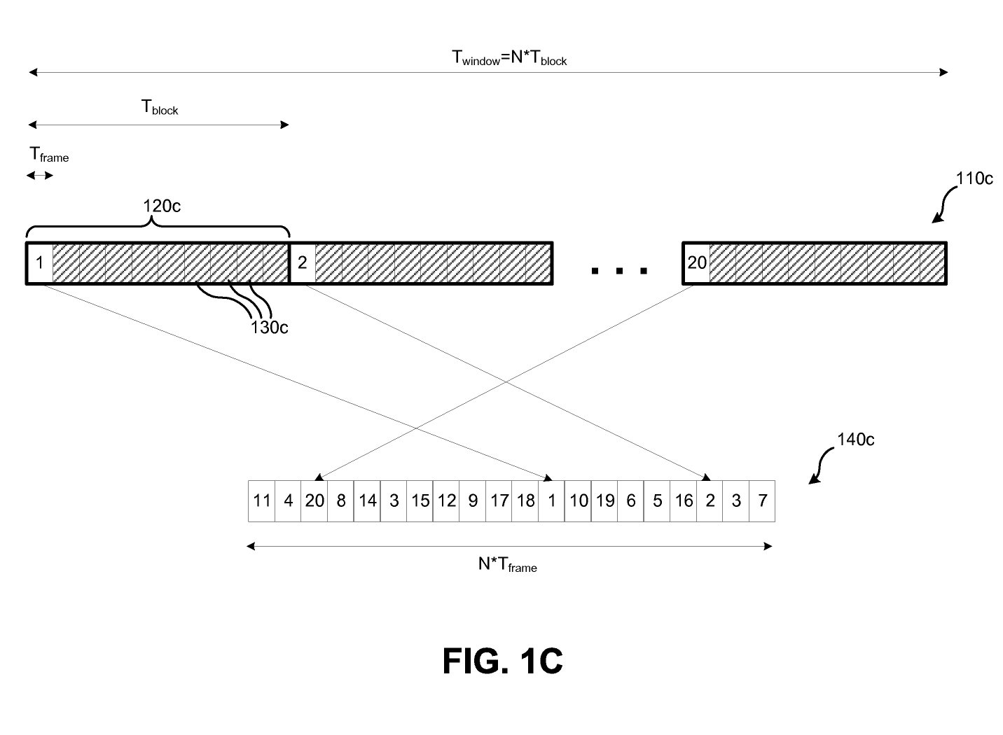

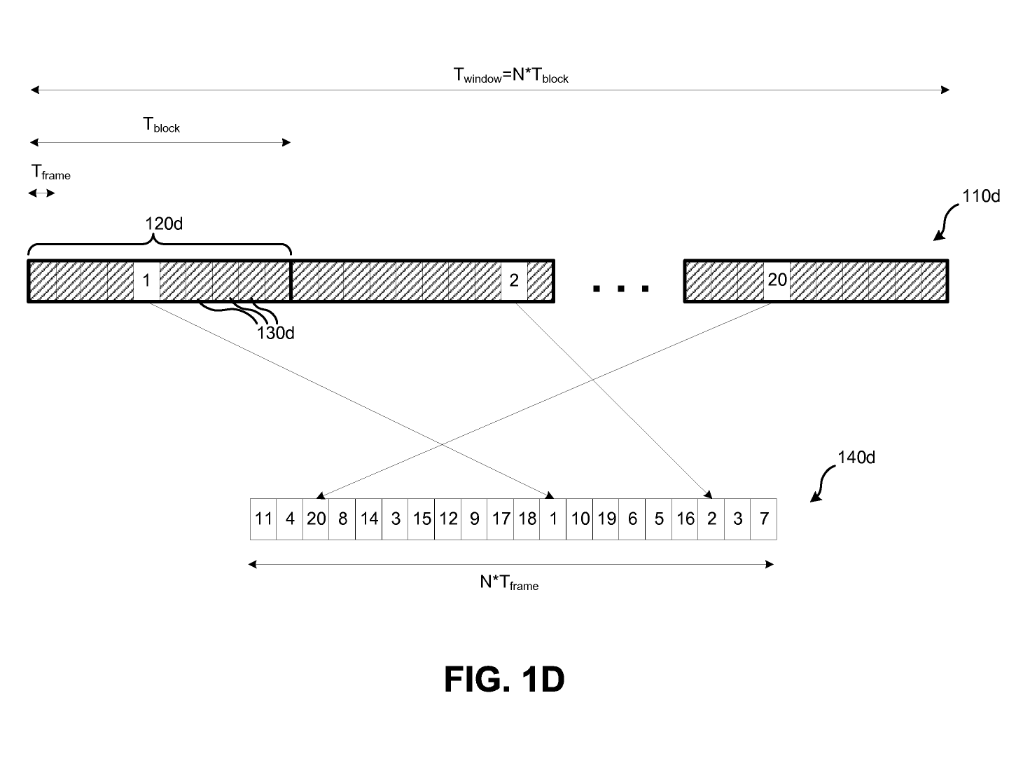

FIG. 1A illustrates an apparatus 100a for learning a user speech model according to one embodiment of the present invention. As shown in FIG. 1A, apparatus 100a can include a mobile device 110a, which may be used by a user 114a. In some embodiments, mobile device 110a can communicate over one or more wireless networks in order to provide data and/or voice communications. For example, mobile device 110a may include a transmitter configured to transmit radio signals, e.g., over a wireless network. Mobile device 110a can represent, for example, a cellular phone, a smart phone, or some other mobile computerized device, such as a tablet computer, laptop, handheld gaming device, digital camera, personal digital assistant, etc. In some embodiments, mobile device 110a can include microphone 112a. Microphone 112a can permit mobile device 110a to collect or capture audio data from the mobile device's surrounding physical environment (e.g., speech being spoken by user 114a).

Microphone 112a may be configured to convert sound waves into electrical or radio signals during select (“active”) time periods. In some instances, whether microphone 112a is active depends at least partly on whether one or more programs or parts of programs are executing on mobile device 110a. For example, microphone 112a may be active only when a particular program is executed, indicating that mobile device 110a is in a call state. In some embodiments, microphone 112a is activated while mobile device 110a is on a call and/or when one or more independent programs are executed. For example, the user may be able to initiate a program to: set up voice-recognition speed dial, record a dictation, etc. In some embodiments, microphone 112a is activated automatically, e.g., during fixed times of the day, at regular intervals, etc.

In some embodiments, privacy sensitive microphone sampling can be used to ensure that no spoken words and/or sentences can be heard or reconstructed from captured audio data while providing sufficient information for speech detection purposes. For example, referring to FIG. 1B, a continuous audio stream in a physical environment can comprise a window 110b of audio data lasting T_{window} seconds and having a plurality of audio portions or data segments. More specifically, the window can comprise N blocks 120b, each block 120b lasting T_{block} seconds and comprising a plurality of frames 130b of T_{frame} seconds each. A microphone signal can be sampled such that only one frame (with T_{frame} seconds of data) is collected in every block of T_{block} seconds. An example of parameter setting includes T_{frame}=50 ms and T_{block}=500 ms, but these settings can vary, depending on desired functionality. For example, frames can range from less than 30 ms to 100 ms or more, blocks can range from less than 250 ms up to 2000 ms (2 s) or more, and windows can be as short as a single block (e.g., one block per window), up to one minute or more. Different frame, block, and window lengths can impact the number of frames per block and the number of blocks per window. Note that frame capturing can be achieved by either continuously sampling the microphone signal and discarding (i.e. not storing) the unwanted components (e.g., 450 ms out of every 500 ms), or by turning the microphone off during the unwanted segment (e.g., turning the microphone off for 450 ms out of every 500 ms).

The resulting audio data 140b is a collection of frames that comprises only a subset of the original audio data. Even so, this subset can still include audio characteristics that can provide for a determination of an ambient environment and/or other contextual information of the audio data with no significant impact on in the accuracy of the determination. In some instances, the subset may also or alternatively be used to identify a speaker (e.g., once a context is inferred). For example, cepstral coefficients may be determined based on the subset of data and compared to speech models.

FIGS. 1C and 1D are similar to FIG. 1B. In FIGS. 1C and 1D, however, additional steps are taken to help ensure further privacy of any speech that may be captured. FIG. 1C illustrates how, for every window of T_{window} seconds, the first frames of every block in a window can be randomly permutated (i.e. randomly shuffled) to provide the resultant audio data 140c. FIG. 1D illustrates a similar technique, but further randomizing the frame captured for each block. For example, where T_{window}=10 and T_{block}=500 ms, 20 frames of microphone data will be captured. These 20 frames then can be being randomly permutated. The random permutation can be computed using a seed that is generated in numerous ways (e.g., based on GPS time, based on noise from circuitry within the mobile device 110a, based on noise from microphone, based on noise from an antenna, etc.). Furthermore, the permutation can be discarded (e.g., not stored) to help ensure that the shuffling effect cannot be reversed.

Other embodiments are contemplated. For example, the blocks themselves may be shuffled before the frames are captured, or frames are captured randomly throughout the entire window (rather than embodiments limiting frame captures to one frame per block), etc. In some embodiments, all frames may be sampled and randomly permutated. In some embodiments, some or all frames may be sampled and mapped onto a feature space. Privacy-protecting techniques may enable processed data (e.g., incomplete frame sampling, permutated frames, mapped data, etc.) to be stored, and it may be unnecessary to store original audio data. It may then be difficult or impossible to back-calculate the original audio signal (and therefore a message spoken into the microphone) based on stored data.

Referring again to FIG. 1A, mobile device 110a can include a processor 142a and a storage device 144a. Mobile device 110a may include other components not illustrated. Storage device 144a can store, in some embodiments, user speech model data 146a. The stored user speech model data can be used to aid in user speech detection. Speech model data 146a may include, e.g., raw audio signals, portions of audio signals, processed audio signals (e.g., normalized signals or filtered signals), feature-mapped audio signals (e.g., cepstral coefficients), environmental factors (e.g., an identity of a program being executed on the phone, whether the mobile device is on a call, the time of day), etc.

As discussed, mobile device 110a can obtain user speech data using one or more different techniques. In some embodiments, a mobile device can be configured to continuously or periodically detect speech over the course of a certain time period. For example, the mobile device can be configured to execute a speech detection program. The speech detection program can be run in the background, and over the course of a day, determine when speech is present in the environment surrounding the mobile device. If speech is detected, audio signals can be recorded by the mobile device (e.g., using microphone 112a).

In some embodiments, audio signals are recorded, e.g., when an input (e.g., from a user) is received indicating that audio data is to be recorded or that a voice-detection program is to be initiated. In some embodiments, audio signals are recorded when a volume of monitored sounds exceeds a threshold; when one or more particular programs or parts of programs (e.g., relating to a mobile device being engaged in a call) is executed; when a mobile device is engaged in a call; when a mobile device is transmitting a signal; etc. In some embodiments, audio data is recorded during defined a defined circumstance (e.g., any circumstance described herein), but only until a sufficient data has been recorded. For example, audio data may cease to be recorded: once a voice-detection program has completed an initialization; once a speech model has exhibited a satisfactory performance; once a defined amount of data has been recorded; etc.

A clustering algorithm can be used to group different types of audio signals collected. Clustering may be performed after all audio data is recorded, between recordings of audio signals, and/or during recordings of audio signals. For example, clustering may occur after audio data is recorded during each of a series of calls. As another example, clustering may occur after an increment of audio data has been recorded (e.g., such that clustering occurs each time an additional five minutes of audio data has been recorded). As yet another example, clustering may be performed substantially continuously until all recorded audio data has been processed by the clustering algorithm. As yet another example, clustering may be performed upon a selection of an option (e.g., an initialization) associated with a voice-detection program configured to be executed on a mobile device.

Audio signals may be clustered such that each group or cluster has similar or identical characteristics (e.g., similar cepstral coefficients). Based at least partly on the number of clusters, mobile device 110a can determine how many speakers were heard over the day. For example, a clustering algorithm may identify ten clusters. It may then be determined that the recorded audio signals correspond to, e.g.: ten speakers, nine speakers (with one cluster being associated with background noise or non-voice sounds), eight speakers (with one cluster being associated with background noise and another associated with non-voice sounds), etc. Characteristics of the clusters (e.g., cepstral coefficients) may also be analyzed to determine whether the cluster likely corresponds to a voice signal.

In some embodiments, a predominate voice cluster is identified. The predominate voice cluster may include a voice cluster that, as compared to other voice clusters, e.g., represents the greatest number of speech segments, is the most dense cluster, etc. In some instances, a predominate voice cluster is not equivalent to a predominate cluster. For example, if audio signals are frequently recorded while no speaker is speaking, a noise cluster may be the predominate cluster. Thus, it may be necessary to identify the predominate cluster only among clusters estimated to include voice signals. Similarly, it may be necessary to remove other clusters (e.g., a cluster estimated to include a combination of voices), before identifying the predominate voice cluster.

In certain embodiments, a mobile device can be configured to obtain user speech data while a user is in a call (e.g., while a call indicator is on). During such “in a call” periods, the mobile device can execute a voice activity detection program to identify when the user is speaking versus listening. Audio data can be collected for those periods when the user is speaking. The collected audio data can thereafter be used to train a user speech model for the user. By obtaining user speech data in this manner, the collected speech data can be of extremely high quality as the users mouth is close to the microphone. Furthermore, an abundance of user speech data can be collected in this fashion. In some embodiments, mobile device 110a can determine whether, during a call, the device is in a speakerphone mode. If it is determined that the device is in a speakerphone mode, speech for the user might not be collected. In this way, it can be made more likely that high quality audio data is collected from the mobile device's user. In certain embodiments, mobile device 110a can additionally detect whether more than one speaker has talked on the mobile device. In the event more than one speaker has talked on the mobile device, audio data associated with only the most frequent speaker can be stored and used to train the user speech model.

In some embodiments, more audio signals are recorded than are used for clustering. For example, audio signals may be non-selectively recorded at all times and/or during an entirety of one or more calls. The audio signals may be processed to identify signals of interest (e.g., having voice-associated cepstral coefficients, or having amplitudes above a threshold). Signals of interest may then be selectively stored, processed, and/or used for clustering. Other signals may, e.g., not be stored and/or may be deleted from a storage device.

According to some embodiments of the present invention, a mobile device can be configured to obtain user speech data while executing a software application known to collect user voice data. Illustratively, the mobile device can collect user speech data while a speech recognition application is being executed.

In some embodiments, a mobile device can be configured to obtain user speech data manually. In particular, the mobile device can enter a manual collection mode during which a user is requested to speak or read text for a certain duration of time. The speech data collection mode can be initiated by the device at any suitable time e.g., on device boot-up, installation of a new application, by the user, etc.

Examples of processes that can be used to learn speech models will now be described.

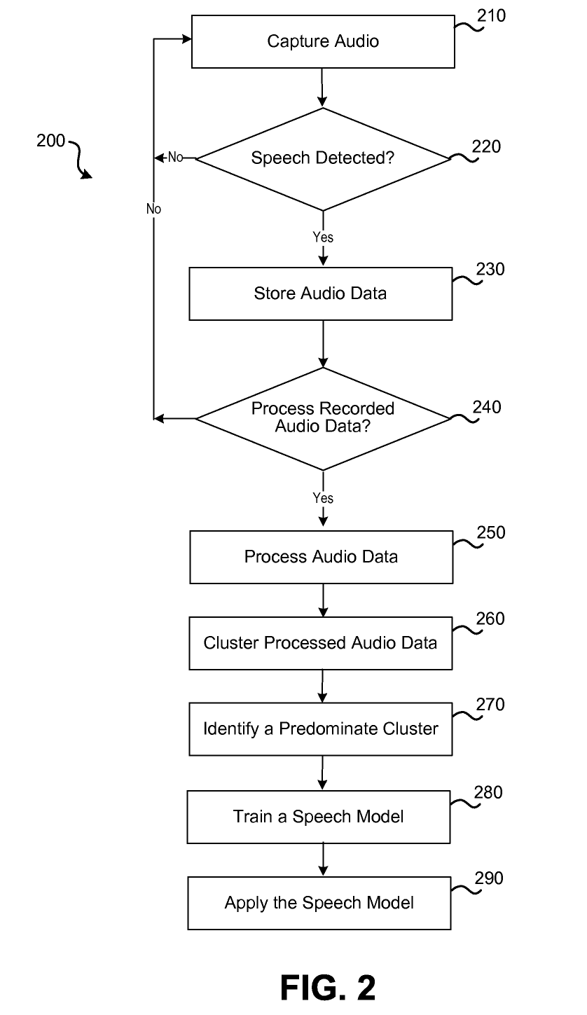

FIG. 2 is a flow diagram of a process 200 for learning speech models according to one embodiment. Part or all of process 200 can be performed by e.g., mobile device 110a shown in FIG. 1A and/or by a computer coupled to mobile device 110a, e.g., through a wireless network.

Process 200 starts at 210 with mobile device 110a capturing audio (e.g., via a microphone and/or a recorder on mobile device 110a). In particular, microphone 112a of mobile device 110a can record audio from the physical environment surrounding the mobile device, as described, e.g., herein. In some embodiments, it is first determined whether mobile device 110a is in an in-call state. For example, a program manager may determine whether a call-related application is being executed, or a radio-wave controller or detector may determine whether radio signals are being transmitted and/or received.

At 220, a decision is made as to whether any captured audio includes segments of speech (e.g., by a speech detector). If speech is detected, the process can proceed to 230. At 230, audio data is stored. The audio data can be stored on, for example, storage device 144a of mobile device 110a or on a remote server. In some instances, part or all of the recorded audio data may be stored regardless of whether speech is detected. The audio data can be captured and/or stored in a privacy sensitive manner.

At 240, it is determined whether any collected audio data (e.g., audio data collected throughout a day) should be clustered. Any suitable criteria may be used to make such a determination. For example, it may be determined that audio data should be clustered because a certain time period has passed, a threshold number of audio datums had been captured, an input (e.g., an input indicating that a voice-detection program should be activated) has been received, etc. In some instances, all captured and/or stored audio data is clustered.

If it is determined that the collected audio data should be processed, the process can proceed to 250. At 250, audio data is processed (e.g., by a filter, a normalizer, a transformation transforming temporal data into frequency-based data, a transformation transforming data into a feature space, etc.). The processing may reduce non-voice components of the signal (e.g., via filtering) and/or may reduce a dimensionality of the signal (e.g., by transforming the signal into a feature space). Processing may include sampling and/or permutating speech signals, such that, e.g., spoken words cannot be reconstructed from the processed data.

At 260, audio data is clustered (e.g., by a classifier, acoustic model and/or a language model). Any clustering technique may be used. For example, one or more of the following techniques may be used to cluster the data: K-means clustering, spectral clustering, quality threshold clustering, principal-component-analysis clustering, fuzzy clustering, independent-component-analysis clustering, information-theory-based clustering, etc. In some instances, a clustering algorithm is continuously or repeatedly performed. Upon the receipt of new (e.g., processed audio data), the clustering algorithm may be re-run in its entirety or only a part of the algorithm may be executed. For example, clusters may initially be defined using an initial set of audio data. New audio data may refine the clusters (e.g., by adding new clusters or contributing to the size of an existing cluster). In some instances, recent audio data or audio data received during particular contexts or of a particular quality (e.g., having a sound amplitude above a threshold), may be more heavily weighted in the clustering algorithm as compared to other audio data.

At 270, a predominate cluster is identified (e.g., by a cluster-characteristic analyzer). The predominate cluster may comprise a predominate voice cluster. The predominate (e.g., voice) cluster may be identified using techniques as described above (e.g., based on a size or density of voice-associated clusters). The predominate cluster may be estimated to be associated with a user's voice.

At 280, audio data associated with the predominate cluster may be used to train a speech model. The speech model may be trained based on, e.g., raw audio data associated with the cluster and/or based on processed audio data. For example, audio data may be processed to decompose audio signals into distinct sets of cepstral coefficients. A clustering algorithm may be executed to cluster the sets of coefficients. A predominate cluster may be identified. A speech model may then be trained based on raw or processed (e.g., normalized, filtered, etc.) temporal audio signals.

A variety of techniques may be used to train a speech model. For example, a speech model may include: an acoustic model, a language model, a Hidden Markov Model, a Gaussian Mixture Model, dynamic time warping-based model, and/or neural-network-based model, etc.

At 290, the speech model is applied. For example, additional collected audio data may be collected subsequent to a training of the speech model. The speech model may be used to determine, e.g., what words were being spoken, whether particular vocal commands were uttered, whether a user was speaking, whether anyone was speaking, etc. Because the speech model may be trained based, primarily, on data associated with a user, it may be more accurate in, e.g., recognizing words spoken by the user. Application of the speech model may also be used to infer a context of the mobile device. For example, identification of a user talking may indicate that the user or device is in a particular context (e.g., the user being near the device, the user being in an un-interruptible state, the user being at work) as compared to others (e.g., the user being in a movie theatre, the user being on public transportation, the user being in an interruptible state, etc.). Further, recognition of certain words may indicate that the user or device is more likely to be in a particular context. For example, recognition of the words, “client”, “meeting”, “analysis”, etc., may suggest that the client is at work rather than at home.

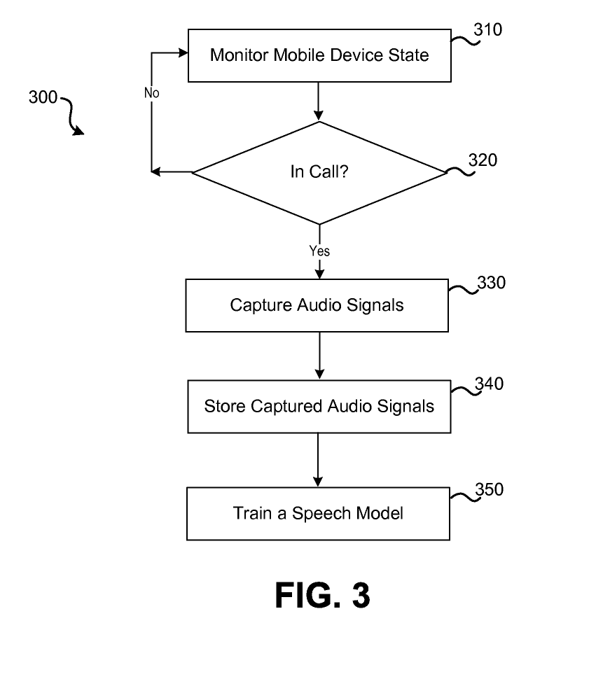

FIG. 3 is a flow diagram of a process 300 for learning speech models according to another embodiment. Part or all of process 300 can be performed by e.g., mobile device 110a and/or by a computer coupled to mobile device 110a (e.g., via a wireless network).

Process 300 starts at 310 with a monitoring of a current state (e.g., currently in a call, etc.) of mobile device 110a. At 320, it is determined whether mobile device 110a is currently in a call. This determination may be made, e.g., by determining whether: one or more programs or parts of programs are being executed, an input (e.g., to initiate a call) was recently received, mobile device 110a is transmitting or receiving radio signals, etc.

If it is determined that mobile device 110a is currently being used to make a call, the process can proceed to 330. At 330, audio signals are captured. Captured audio signals may include all or some signals that were: transmitted or received during the call; transmitted during the call; identified as including voice signals; and/or identified as including voice signals associated with a user.

At 340, captured audio signals are stored. All or some of the captured signals are stored. For example, an initial processing may be performed to determine whether captured audio signals included voice signals or voice signals associated with a user, and only signals meeting such criteria may be stored. As another example, a random or semi-random selection of captured audio frames may be stored to conserve storage space. Audio data can be captured and/or stored in a privacy sensitive manner.

At 350, the stored audio data are used to train a speech model. The speech model may be trained using all or some of the stored audio data. In some instances, the speech model is trained using processed (e.g., filtered, transformed, normalized, etc.) audio data. In some instances, a clustering algorithm is performed prior to the speech-model training to, e.g., attempt to ensure that signals not associated with speech and/or not associated with a user's voice are not processed. A variety of techniques may be used to train a speech model. For example, a speech model may include: an acoustic model, a language model, a Hidden Markov model, dynamic time warping-based model, and/or neural-network-based model, etc.

Process 300 may, e.g., be performed entirely on a mobile device or partly at a mobile device and partly at a remote server. For example, 310-330 may be performed at a mobile device and 340-350 at a remote server.

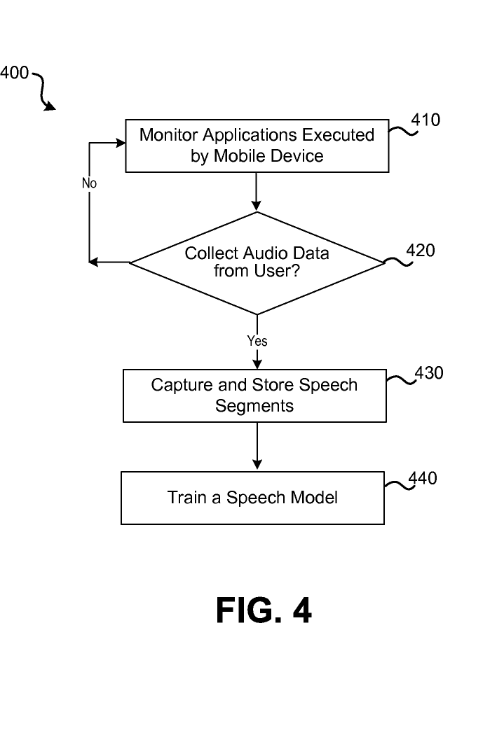

FIG. 4 is a flow diagram of a process 400 for learning speech models according to still another embodiment. Part or all of process 400 can be performed by e.g., mobile device 110a and/or by a computer coupled to mobile device 110a (e.g., via a wireless network).

Process 400 starts at 410 with mobile device 110a monitoring one, more or all software applications currently being executed by the mobile device (e.g., a speech recognition program).

At 420, it is determined whether an executed application collects audio data including speech from the mobile device user. For example, the determination may include determining whether: a program is of a predefined audio-collecting-program set; a program activates a microphone of the mobile device; etc.

If it is determined that the application does collect such audio data, the process can proceed to 430. At 430, the mobile device captures and stores audio data. Audio data may be captured, stored, and processed using, e.g., techniques as described above The audio data can be captured and/or stored in a privacy sensitive manner. The audio data can include speech segments spoken by the user. At step 440, mobile device 110a can use the audio data to train a speech model. The speech model may be trained as described above.

Process 400 may, e.g., be performed entirely on a mobile device or partly at a mobile device and partly at a remote server. For example, 410-430 may be performed at a mobile device and 440 at a remote server.

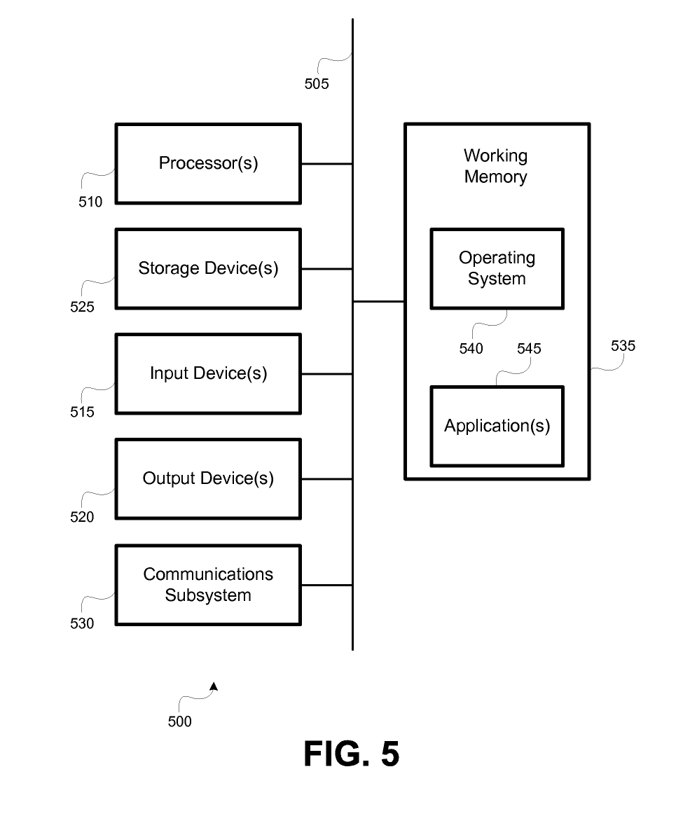

A computer system as illustrated in FIG. 5 may incorporate as part of the previously described computerized devices. For example, computer system 500 can represent some of the components of the mobile devices and/or the remote computer systems discussed in this application. FIG. 5 provides a schematic illustration of one embodiment of a computer system 500 that can perform all or part of methods described herein the methods described herein. It should be noted that FIG. 5 is meant only to provide a generalized illustration of various components, any or all of which may be utilized as appropriate. FIG. 5, therefore, broadly illustrates how individual system elements may be implemented in a relatively separated or relatively more integrated manner.

The computer system 500 is shown comprising hardware elements that can be electrically coupled via a bus 505 (or may otherwise be in communication, as appropriate). The hardware elements may include one or more processors 510, including without limitation one or more general-purpose processors and/or one or more special-purpose processors (such as digital signal processing chips, graphics acceleration processors, and/or the like); one or more input devices 515, which can include without limitation a mouse, a keyboard and/or the like; and one or more output devices 520, which can include without limitation a display device, a printer and/or the like.

The computer system 500 may further include (and/or be in communication with) one or more storage devices 525, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 500 might also include a communications subsystem 530, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 530 may permit data to be exchanged with a network (such as the network described below, to name one example), other computer systems, and/or any other devices described herein. In many embodiments, the computer system 500 will further comprise a working memory 535, which can include a RAM or ROM device, as described above.

The computer system 500 also can comprise software elements, shown as being currently located within the working memory 535, including an operating system 540, device drivers, executable libraries, and/or other code, such as one or more application programs 545, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 525 described above. In some cases, the storage medium might be incorporated within a computer system, such as the system 500. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 500 and/or might take the form of source and/or installable code, which, upon compilation and/or installation on the computer system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 500) to perform methods in accordance with various embodiments of the invention. According to a set of embodiments, some or all of the procedures of such methods are performed by the computer system 500 in response to processor 510 executing one or more sequences of one or more instructions (which might be incorporated into the operating system 540 and/or other code, such as an application program 545) contained in the working memory 535. Such instructions may be read into the working memory 535 from another computer-readable medium, such as one or more of the storage device(s) 525. Merely by way of example, execution of the sequences of instructions contained in the working memory 535 might cause the processor(s) 510 to perform one or more procedures of the methods described herein.

The terms “machine-readable medium” and “computer-readable medium,” as used herein, refer to any medium that participates in providing data that causes a machine to operate in a specific fashion. Computer readable medium and storage medium do not refer to transitory propagating signals. In an embodiment implemented using the computer system 500, various computer-readable media might be involved in providing instructions/code to processor(s) 510 for execution and/or might be used to store such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 525. Volatile media include, without limitation, dynamic memory, such as the working memory 535.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, etc.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

What is claimed is:

1. A method for training a user speech model, the method comprising:
accessing audio data captured while a mobile device is in an in-call state;
clustering the captured audio data into a plurality of clusters, each cluster of the plurality of clusters being associated with one or more audio segments from the accessed audio data;
identifying a predominate voice cluster; and
training the user speech model based, at least in part, on audio data associated with the predominate voice cluster.

2. The method of claim 1, further comprising: determining that the mobile device is currently in the in-call state.

3. The method of claim 2, wherein determining that a mobile device is currently in an in-call state comprises determining that the mobile device is currently executing a software application, wherein the software application collects user speech.

4. The method of claim 1, further comprising: receiving, at a remote server, the audio data from the mobile device.

5. The method of claim 1, wherein identifying the predominate voice cluster comprises:
identifying one or more of the plurality of clusters as voice clusters, each of the identified voice cluster being primarily associated with audio segments estimated to include speech; and
identifying a select voice cluster amongst the identified voice clusters that, relative to all other voice clusters, is associated with the greatest number of audio segments.

6. The method of claim 1, wherein identifying the predominate voice cluster comprises:
identifying a cluster that, relative to all other clusters, is associated with the greatest number of audio segments.

7. The method of claim 1, wherein the user speech model is trained only using the audio data captured while the mobile device was in the in-call state.

8. The method of claim 1, wherein the user speech model is trained after the predominate voice cluster is identified.

9. The method of claim 1, further comprising: storing at least part of the accessed audio data, wherein it is not possible to reconstruct a message spoken during the in-call state by a speaker based on the stored accessed audio data.

10. The method of claim 1, wherein the user speech model is trained to recognize words spoken by a user of the mobile device.

11. The method of claim 1, further comprising:
analyzing a second set of audio data using the user speech model;
recognizing, based on the analyzed second set of audio data, one or more particular words spoken by a user; and
inferring a context at least partly based on the recognized one or more words.

12. The method of claim 1, further comprising:
accessing second audio data captured while the mobile device is in a second and distinct in-call state;
clustering the accessed second audio data;
identifying a subsequent predominate voice cluster; and
training the user speech model based, at least in part, on audio data associated with the subsequent predominate voice cluster.

13. The method of claim 1, further comprising:
storing the accessed audio data;
determining a plurality of cepstral coefficients associated with each of a plurality of portions of the accessed audio data;
clustering the accessed audio data based on the determined plurality of cepstral coefficients, and
training the user speech model based, at least in part, on the stored audio data, wherein the stored audio data comprises temporally varying data.

14. The method of claim 1, wherein the user speech model comprises a Hidden Markov Model.

15. The method of claim 1, wherein the user speech model comprises a Gaussian Mixture Model.

16. The method of claim 1, further comprising:
accessing second audio data captured after a user was presented with text to read, the accessed second audio data including a second set of speech segments, wherein the second set of speech segments are based on the presented text; and
training the user speech model based, at least in part, on the second set of speech segments.

17. The method of claim 1, wherein the audio data comprises data collected across a plurality of calls.

18. An apparatus for training a user speech model, the apparatus comprising:
a mobile device comprising:
a microphone configured to, upon being in an active state, receive audio signals and convert the received audio signals into radio signals; and
a transmitter configured to transmit the radio signals; and
one or more processors configured to:
determine that the microphone is in the active state;
capture audio data while the microphone is in the active state;
cluster the captured audio data into a plurality of clusters, each cluster of the plurality of clusters being associated with one or more audio segments from the captured audio data;
identify a predominate voice cluster; and
train the user speech model based, at least in part, on audio data associated with the predominate voice cluster.

19. The apparatus of claim 18, wherein the mobile device comprises at least one of the one or more processors.

20. The apparatus of claim 18, wherein the mobile device comprises all of the one or more processors.

21. The apparatus of claim 18, wherein the mobile device is configured to execute at least one software application that activate the microphone.

22. The apparatus of claim 18, wherein the audio data is captured only when the mobile device is engaged in a telephone call.

23. A computer-readable medium containing a program which executes the steps of:
accessing audio data captured while a mobile device is in an in-call state;
clustering the accessed audio data into a plurality of clusters, each cluster of the plurality of clusters being associated with one or more audio segments from the accessed audio data;
identifying a predominate voice cluster; and
training the user speech model based, at least in part, on audio data associated with the predominate voice cluster.

24. The computer-readable medium of claim 23, wherein the step of identifying the predominate voice cluster comprises identifying a cluster that, relative to all other clusters, is associated with the greatest number of audio segments.

25. The computer-readable medium of claim 23, wherein the program further executes the step of: storing at least part of the accessed audio data, wherein it is not possible to reconstruct a message spoken during the in-call state by a speaker based on the stored data.

26. The computer-readable medium of claim 23, wherein the program further executes the steps of:
storing the accessed audio data;
determining a plurality of cepstral coefficients associated with each of a plurality of portions of the accessed audio data;
clustering the accessed audio data based on the determined cepstral coefficients, and
training the user speech model based, at least in part, on the stored audio data, wherein the stored audio data comprises temporally varying data.

27. A system for training a user speech model, the system comprising:
means for accessing audio data captured while a mobile device is in an in-call state;
means for clustering the accessed audio data into a plurality of clusters, each cluster of the plurality of clusters being associated with one or more audio segments from the accessed audio data;
means for identifying a predominate voice cluster; and
means for training the user speech model based, at least in part, on audio data associated with the predominate voice cluster.

28. The system of claim 27, wherein the means for training the user speech model comprises means for training Hidden Markov Model.

29. The system of claim 27, wherein the predominate voice cluster comprises a voice cluster associated with a highest number of audio frames.

30. The system of claim 27, further comprising means for identifying at least one of the clusters associated with one or more speech signals.
